(19) United States
(12) Patent Application Publication
(10) Pub. No.: US 2026/0018335 A1
(43) Pub. Date: Jan. 15, 2026

(54) ELECTRONIC COMPONENT

(71) Applicant: Murata Manufacturing Co., Ltd., Nagaokakyo-shi (JP)

(72) Inventors: Masashi ARAI, Nagaokakyo-shi (JP); Yosuke MATSUSHITA, Nagaokakyo-shi (JP)

(73) Assignee: Murata Manufacturing Co., Ltd., Nagaokakyo-shi (JP)

(21) Appl. No.: 19/332,139

(22) Filed: Sep. 18, 2025

Related U.S. Application Data
(63) Continuation of application No. PCT/JP2024/005794, filed on Feb. 19, 2024.

(30) Foreign Application Priority Data
Mar. 28, 2023 (JP) 2023-051276

(51) Int. Cl. H01G 2/00; H01G 4/228

(52) U.S. Cl. CPC H01G 2/00; H01G 4/228

(57) ABSTRACT

An electronic component includes a component main body, an external electrode, and a protective member. The component main body has a lower surface. The external electrode includes a base layer. The base layer is in contact with the lower surface. The protective member is in contact with the lower surface and the base layer, is along an external edge of the base layer so as to surround the base layer, and does not project in a down direction below the lower surface.

### CROSS-REFERENCE TO RELATED APPLICATIONS

The present application is bypass continuation of International Application PCT/JP2024/005794, filed Feb. 19, 2024, and 2023-051276, filed Mar. 28, 2023, the entire contents of each of which being incorporated herein by reference.

### TECHNICAL FIELD

The present disclosure relates to an electronic component.

### BACKGROUND ART

In a known ceramic electronic component, e.g., as disclosed in Patent Literature 1, a coating layer is provided so that at least a part of a peripheral portion of an external terminal electrode provided in a ceramic layer may be covered. According to this, the peripheral portion of the external terminal electrode is protected. As a result, the external terminal electrode is significantly reduced from separating from the ceramic layer.

### CITATION LIST

### Patent Literature

[Patent Literature 1] Japanese Patent No. 5708798

### SUMMARY

### Technical Problems

Incidentally, in the field of the ceramic electronic component disclosed in Patent Literature 1, there is a demand for significantly reducing a defect of a coating layer.

In view of the foregoing, exemplary embodiments of the present invention are directed to provide an electronic component capable of significantly reducing a defect of a protective member.

### Solutions to Problems

An electronic component according to an exemplary embodiment of the present invention includes a component main body, an external electrode, and a protective member, and the component main body has a lower surface, the external electrode includes a base layer, the base layer is in contact with the lower surface, and the protective member is in contact with the lower surface and the base layer, is along an external edge of the base layer so as to surround the base layer, and does not project in a down direction below the lower surface.

### Advantageous Effects

According to the electronic component of the present disclosure, a defect of a protective member is able to be significantly reduced.

### BRIEF DESCRIPTION OF DRAWINGS

FIG. 1 is an external perspective view of an electronic component 10.

FIG. 2 is a bottom view of the electronic component 10.

FIG. 3 and FIG. 4 show bottom views and cross-sectional views of the electronic component 10.

FIG. 5 is a cross-sectional view of a conventional electronic component 110.

FIG. 6 is a cross-sectional view of the electronic component 10.

FIG. 7 is a cross-sectional view of an electronic component 10a.

FIG. 8 shows a bottom view and cross-sectional view of an electronic component 10b.

FIG. 9 is a bottom view of an electronic component 10c.

### DESCRIPTION OF EXEMPLARY EMBODIMENTS

### Exemplary Embodiment

### [Structure of Electronic Component 10]

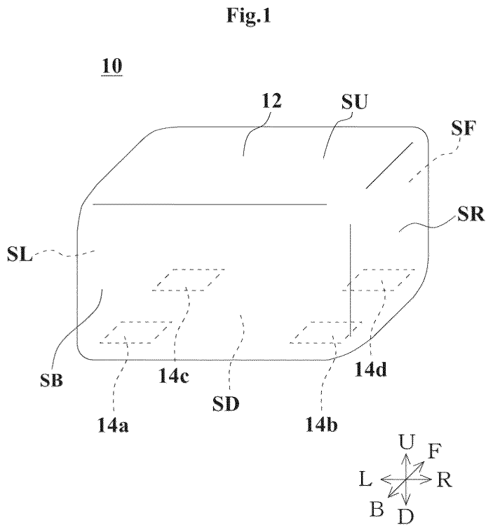

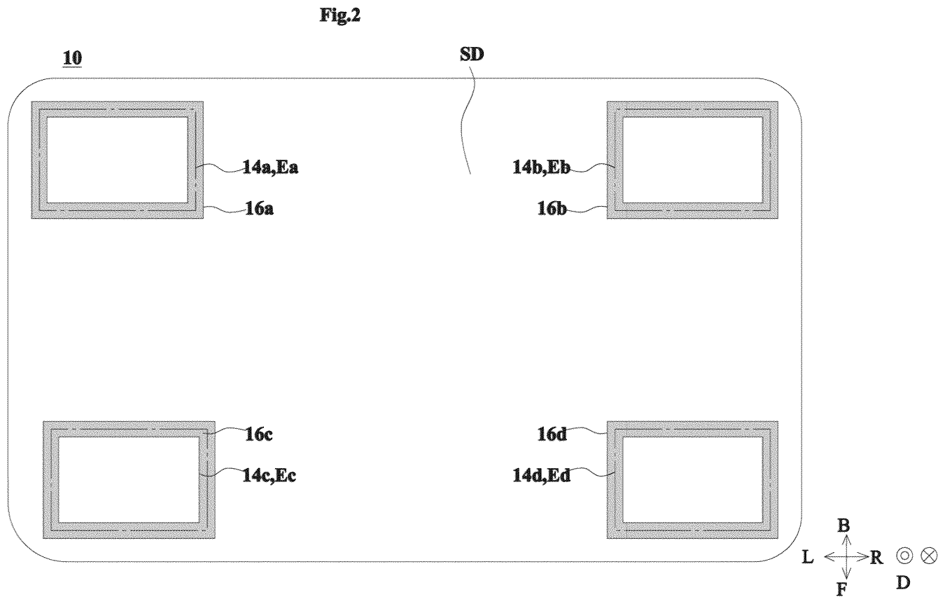

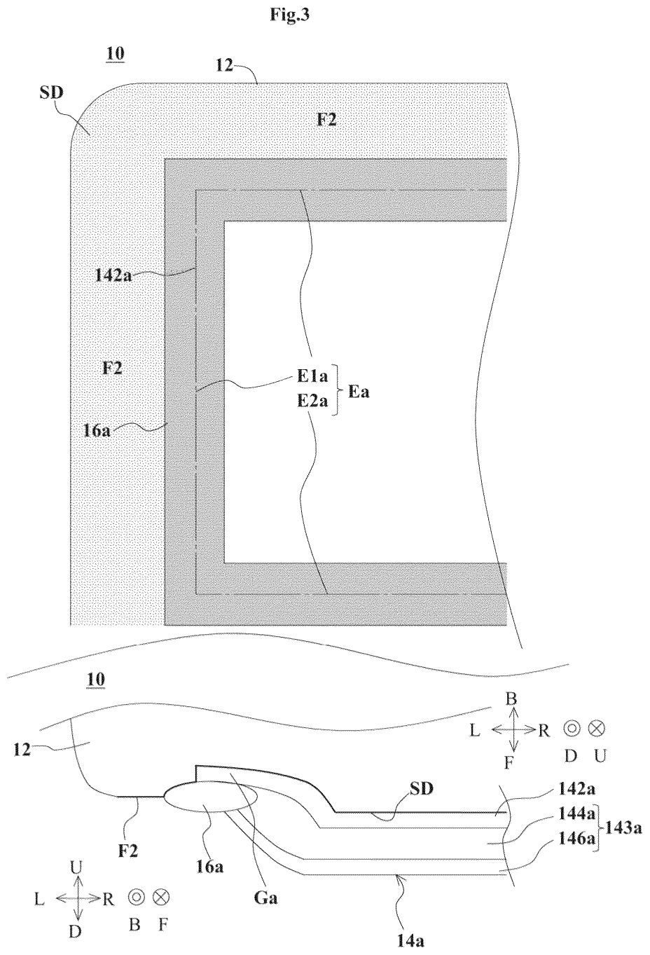

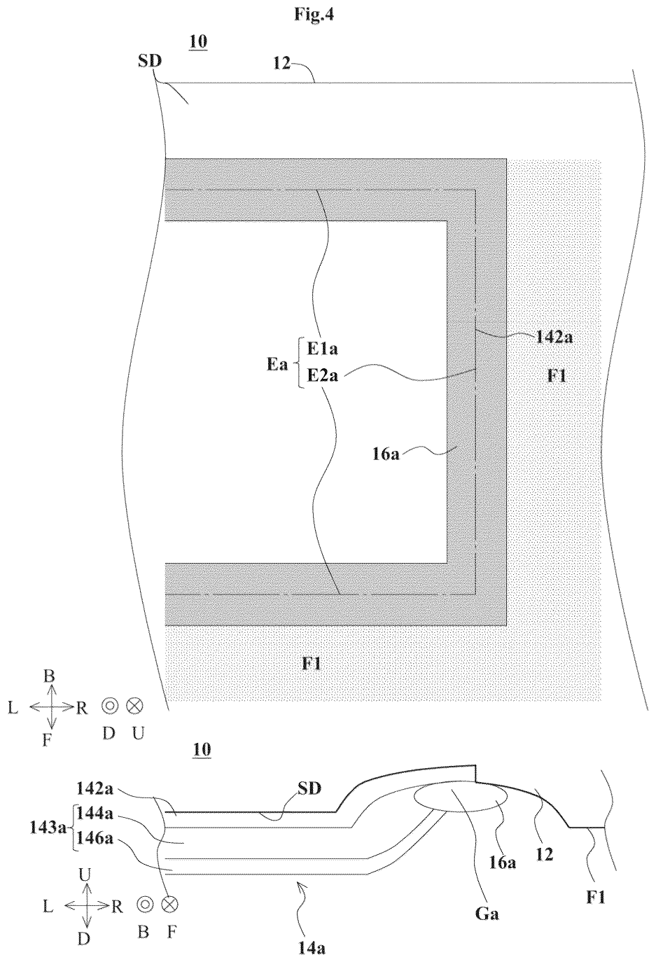

Hereinafter, a structure of an electronic component 10 according to exemplary embodiments of the present disclosure will be described with reference to drawings. FIG. 1 is an external perspective view of the electronic component 10. FIG. 2 is a bottom view of the electronic component 10. FIG. 3 and FIG. 4 show bottom views and cross-sectional views of the electronic component 10. In the cross-sectional views, a lower surface SD is indicated by a bold line.

In the present specification, directions are defined as follows. A direction in which a plurality of insulator layers are stacked is defined as an up-down direction. The directions orthogonal to the up-down direction are defined as a left-right direction and a front-back direction. The left-right direction and the front-back direction are orthogonal to each other. It is to be noted that the up-down direction, the front-back direction, and the left-right direction in the present exemplary embodiment may not match the up-down direction, the front-back direction, and the left-right direction during the use of the electronic component 10.

First, the structure of the electronic component 10 will be described with reference to FIG. 1 and FIG. 2. The electronic component 10 is, for example, used for a wireless communication terminal such as a smartphone. As shown in FIG. 1, the electronic component 10 includes a component main body 12, external electrodes 14a-14d, and protective members 16a-16d.

The component main body 12 has a structure in which a plurality of insulator layers are stacked in the up-down direction. The component main body 12 has a rectangular parallelepiped shape. The component main body 12, as shown in FIG. 1, has an upper surface SU, a lower surface SD, a left surface SL, a right surface SR, a front surface SF, and a back surface SB. The upper surface SU is oriented in the up direction. The lower surface SD is oriented in the down direction. The left surface SL, the right surface SR, the front surface SF, and the back surface SB are side surfaces located between the lower surface SD and the upper surface SU.

In addition, each edge of the component main body 12 is rounded. A material of the component main body 12 described above is ceramic.

The external electrodes 14a-14d are provided on the lower surface SD. The external electrode 14a is located near a left back corner of the lower surface SD. The external electrode 14b is located near a right back corner of the lower surface SD. The external electrode 14c is located near a left front corner of the lower surface SD. The external electrode 14d is located near a right front corner of the lower surface SD. The external electrodes 14a-14d, when viewed in the up direction, have a rectangular shape.

Hereinafter, a structure of the external electrode 14a will be described with reference to FIG. 3 and FIG. 4. The external electrode 14a includes a base layer 142a and a plating layer 143a. The base layer 142a is in contact with the lower surface SD. The base layer 142a, when viewed in the up direction, has an external edge Ea having a rectangular shape. When viewed in the up direction, the external edge Ea of the base layer 142a includes a facing portion Ela that faces an external edge of the lower surface SD and a non-facing portion E2a that does not face the external edge of the lower surface SD. The facing portion Ela and the external edge of the lower surface SD face each other, which means that other electrodes are not present between the facing portion Ela and the external edge of the lower surface SD. In the present exemplary embodiment, the facing portion Ela is the left side and the back side of the base layer 142a. The non-facing portion E2a is the right side and the front side of the base layer 142a. The plating layer 143a will be described later.

The protective member 16a is in contact with the lower surface SD and the base layer 142a and is along an external edge of the base layer 142a so as to surround the base layer 142a. In the present exemplary embodiment, the protective member 16a has a rectangular ring shape. According to this, when viewed in the up direction, the entirety of an external edge Ea of the base layer 142a overlaps with the protective member 16a. A material of the protective members 16a-16d described above is ceramic. The material of the protective members 16a-16d is the same as the material of the component main body 12.

The plating layer 143a is located below the base layer 142a and is in contact with the base layer 142a. The plating layer 143a includes a Ni layer 144a and a Sn layer 146a. The Ni layer 144a contacts the base layer 142a. The Ni layer 144a covers the base layer 142a. The Sn layer 146a contacts the Ni layer 144a. The Sn layer 146a covers the Ni layer 144a. However, an external edge of the plating layer 143a does not contact the base layer 142a but contacts the protective member 16a. Therefore, the external edge of the plating layer 143a is located below the protective member 16a.

Next, a shape of the lower surface SD of the component main body 12 will be described. The lower surface SD includes a first flat-shaped portion F1 and a second flat-shaped portion F2. The first flat-shaped portion F1 is oriented in the down direction while being along the non-facing portion E2a. The second flat-shaped portion F2 is oriented in the down direction while being along the facing portion Ela. The first flat-shaped portion F1 and the second flat-shaped portion F2 are substantially flat. However, the first flat-shaped portion F1 and the second flat-shaped portion F2 may have irregularities and warping by manufacturing variations.

In addition, when viewed in the down direction, a depressed portion Ga that overlaps with the protective member 16a is provided on the lower surface SD. The depressed portion Ga, when viewed in the down direction, overlaps with the protective member 16a. The depressed portion Ga, when viewed in the down direction, has a rectangular ring shape. According to this, a lower end of the protective member 16a is located above the first flat-shaped portion F1. In addition, a position of the lower end of the protective member 16a in an up-down axis is substantially the same as a position of the second flat-shaped portion F2 in the up-down axis. Therefore, the first flat-shaped portion F1 is located below the second flat-shaped portion F2. As described above, the protective member 16a does not project in the down direction below the lower surface SD.

As the structure of the external electrodes 14b-14d and the protective members 16b-16d is the same as the structure of the external electrode 14a and the protective member 16a, the description not be repeated.

The electronic component 10 described above is mounted on a circuit board by solder. The solder is applied to the external electrodes 14a-14d. Then, the external electrodes 14a-14d are fixed to external electrodes of the circuit board by the solder.

### Advantageous Effects

According to the electronic component 10, a defect of the protective member 16a is able to be significantly reduced. More specifically, the protective member 16a does not project in the down direction below the lower surface SD. Accordingly, when the electronic component 10 is mounted on the circuit board, the protective member 16a is significantly reduced from colliding with the circuit board. As a result, a defect of the protective member 16a is significantly reduced.

In the electronic component 10, when viewed in the down direction, the depressed portion Ga that overlaps with the protective member 16a is provided on the lower surface SD. According to this, the protective member 16a becomes depressed with respect to the lower surface SD. On the other hand, the external electrode 14a is not depressed with respect to the lower surface SD. According to this, when the plating layer 143a is formed, e.g., by an electroplating process, a plating solution can more easily contacts the base layer 142a. As a result, formation failure of the plating layer 143a is significantly reduced.

In the electronic component 10, the position of the lower end of the protective member 16a in the up-down axis is substantially the same as the position of the second flat-shaped portion F2 in the up-down axis. According to this, a projection is significantly reduced from being formed on the lower surface SD between the external edge of the lower surface SD and the non-facing portion E2a. As a result, the occurrence of a failure of the electronic component 10 due to a defect of the projection is significantly reduced.

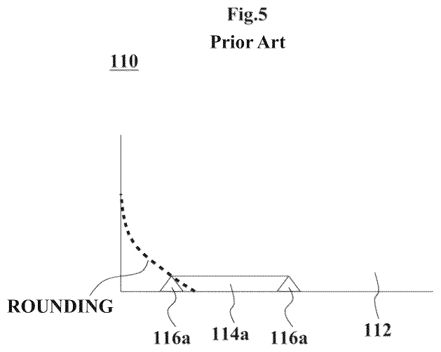

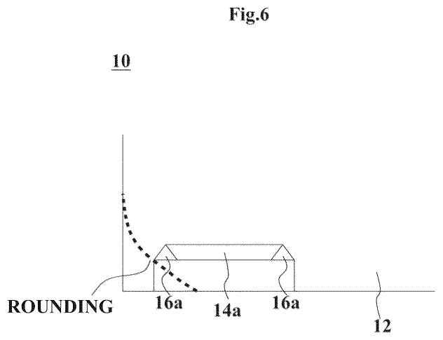

In the electronic component 10, the protective member 16a is significantly reduced from being shaved by barrel polishing of the electronic component 10. FIG. 5 is a cross-sectional view of a conventional electronic component 110. FIG. 6 is a cross-sectional view of the electronic component 10. The barrel polishing rounds a corner defined by the lower surface SD and the left surface SL of the component main body 12. In the conventional electronic component 110, the protective member 116 easily is susceptible to being damaged or removed by the polishing process. On the other hand, in the electronic component 10, the protective member 16a does not project in the down direction below the lower surface SD. Therefore, the protective member 116 does not easily disappear due to polishing. Furthermore, the external electrode 14a is able to approach the external edge of the lower surface SD. Therefore, the electronic component 10 is able to be miniaturized.

In the electronic component 10, a level difference is made between the lower surface SD and the external electrode 14a. This level difference functions as a solder stop at the time of mounting and improves solder splash resistance at the time of molding.

The external edge of the plating layer 143a contacts the protective member 16a, so that stress applied to a chip, e.g., the component main body 12, of the electronic component 10 after mounting is distributed to a boundary between the base layer 142a and the plating layer 143a and a boundary between the base layer 142a and the lower surface SD. According to this, the external electrode 14a is significantly reduced from separating from the component main body 12.

### First Modification

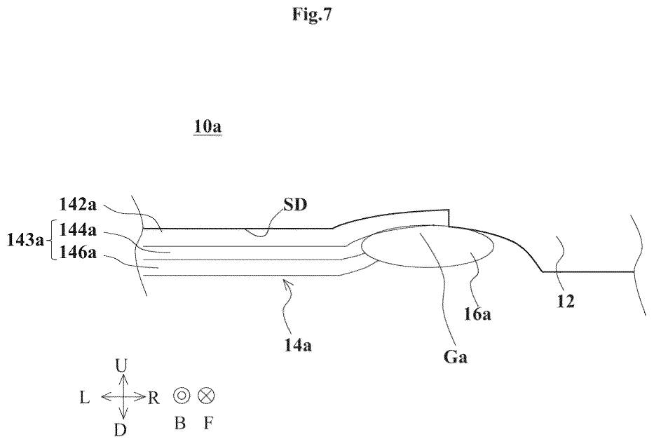

Hereinafter, an electronic component 10a according to a first modification of the present disclosure will be described with reference to drawings. FIG. 7 is a cross-sectional view of the electronic component 10a.

The electronic component 10a is different from the electronic component 10 in that the position of the lower surface of the external electrode 14a in the up-down axis is substantially the same as the position of the lower surface SD in the up-down axis. Since the remaining structure of the electronic component 10a is the same as the structure of the electronic component 10, the description will be not be repeated.

### Second Modification

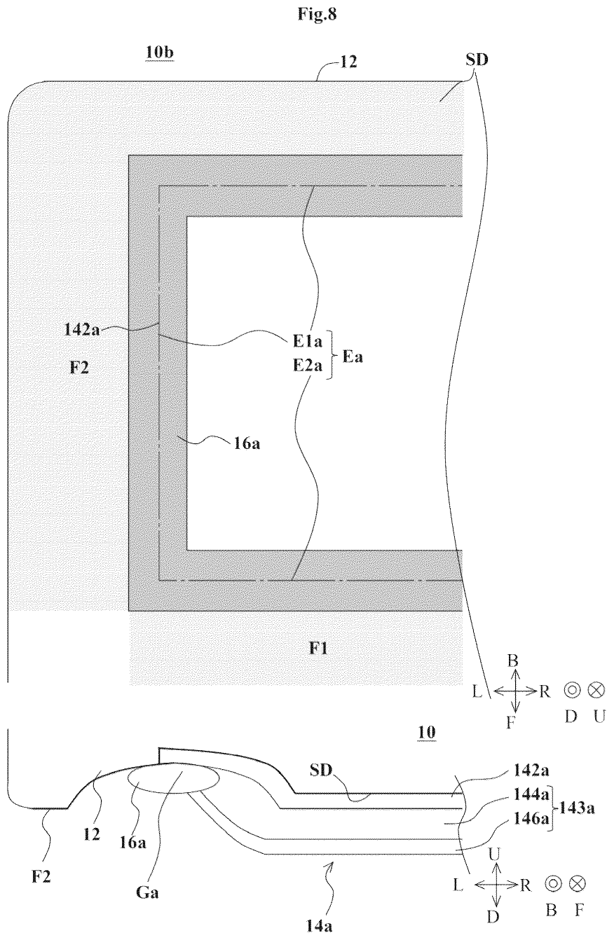

Hereinafter, an electronic component 10b according to a second modification of the present disclosure will be described with reference to drawings. FIG. 8 shows a bottom view and cross-sectional view of the electronic component 10b.

The electronic component 10b is different from the electronic component 10 in that the lower end of the protective member 16a is located above the second flat-shaped portion F2. Since the remaining structure of the electronic component 10b is the same as the structure of the electronic component 10, the description will not be repeated.

### Third Modification

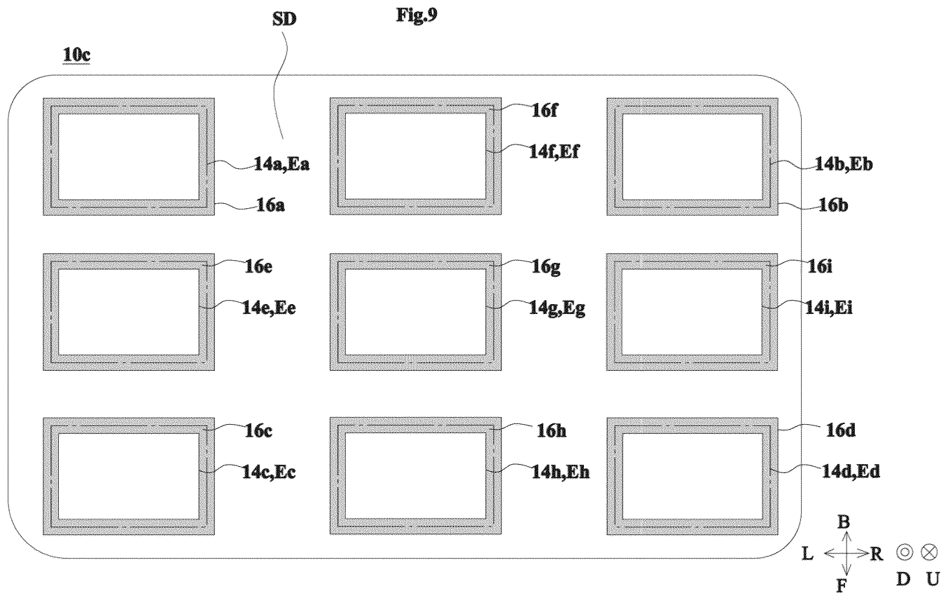

Hereinafter, an electronic component 10c according to a third modification of the present disclosure will be described with reference to drawings. FIG. 9 shows a bottom view of the electronic component 10c.

The electronic component 10c further includes external electrodes 14e-14i. In the external electrode 14e, the second flat-shaped portion F2 is located on the left of the external electrode 14e. In the external electrode 14f, the second flat-shaped portion F2 is located at the back of the external electrode 14f. In the external electrode 14h, the second flat-shaped portion F2 is located in front of the external electrode 14h. In the external electrode 14i, the second flat-shaped portion F2 is located on the right of the external electrode 14i. In addition, the external electrode 14g is surrounded by the first flat-shaped portion F1. Since the remaining structure of the electronic component 10c is the same as the structure of the electronic component 10, the description will not be repeated.

### Other Exemplary Embodiments

The electronic components according to the present disclosure are not limited to the electronic components 10 and 10a-10c, and various changes and modifications may be possible within the scope of the present disclosure. In addition, the structures of the electronic components 10 and 10a-10c may be optionally combined.

It is to be noted that an Au layer may be provided instead of the Sn layer.

The material of the protective members 16a-16d may not be ceramic.

The material of the component main body 12 may not be ceramic.

The material of the protective members 16a-16d may be different from the material of the component main body 12.

It is to be noted that the protective member 16a, when viewed in the up direction, may not have a ring shape.

It is to be noted that the external electrode 14a, when viewed in the up direction, may have a shape other than a rectangular shape. It is to be noted that the rectangular shape includes a square. The shape other than a rectangular shape is, for example, a circular shape or an elliptical shape.

The present disclosure includes the following structure.

(1)

An electronic component in which the electronic component includes a component main body, an external electrode, and a protective member, and the component main body has a lower surface, the external electrode includes a base layer, the base layer is in contact with the lower surface, and the protective member is in contact with the lower surface and the base layer, is along an external edge of the base layer so as to surround the base layer, and does not project in a down direction below the lower surface.

(2)

The electronic component according to (1) in which, when viewed in an up direction, the external edge of the base layer includes a facing portion that faces an external edge of the lower surface, and a non-facing portion that does not face the external edge of the lower surface, the lower surface includes a first flat-shaped portion oriented in the down direction while being along the non-facing portion, and a lower end of the protective member is located above the first flat-shaped portion.

(3)

The electronic component according to (1) or (2) in which the protective member has a ring shape.

(4)

The electronic component according to (2) in which the lower surface includes a second flat-shaped portion oriented in the down direction while being along the facing portion, and the lower end of the protective member is located above the second flat-shaped portion.

(5)

The electronic component according to (2) in which the lower surface includes a second flat-shaped portion oriented in the down direction while being along the facing portion; and a position of the lower end of the protective member in an up-down axis is substantially the same as a position of the second flat-shaped portion in the up-down axis.

(6)

The electronic component according to any of (1) to (5) in which, when viewed in the down direction, a depressed portion that overlaps with the protective member is provided on the lower surface.

(7)

The electronic component according to any of (1) to (6) in which the external electrode further includes a plating layer, and the plating layer is located below the base layer and is in contact with the base layer.

(8)

The electronic component according to (7) in which an external edge of the plating layer is located below the protective member.

### REFERENCE SIGNS LIST

10, 10a-10c: electronic component
12: component main body
14a-14h: external electrode
16a-16h: protective member
142a: base layer
143a: plating layer
144a: Ni layer
146a: Sn layer
E1a: facing portion
E2a: non-facing portion
Ea: external edge
F1: first flat-shaped portion
F2: second flat-shaped portion
Ga: depressed portion
SB: back surface
SD: lower surface
SF: front surface
SL: left surface
SR: right surface
SU: upper surface

1. An electronic component comprising:
a component main body;
an external electrode; and
a protective member, wherein:
the component main body has a lower surface;
the external electrode includes a base layer;
the base layer is in contact with the lower surface; and
the protective member is in contact with the lower surface and the base layer, is along an external edge of the base layer so as to surround the base layer, and does not project in a down direction below the lower surface.

2. The electronic component according to claim 1, wherein:
when viewed in an up direction, the external edge of the base layer includes a facing portion that faces an external edge of the lower surface, and a non-facing portion that does not face the external edge of the lower surface;
the lower surface includes a first flat-shaped portion oriented in the down direction while being along the non-facing portion; and
a lower end of the protective member is located above the first flat-shaped portion.

3. The electronic component according to claim 2, wherein the facing portion is adjacent an external edge of the lower surface and the non-facing portion is adjacent another external electrode.

4. The electronic component according to claim 2, wherein the protective member has a ring shape.

5. The electronic component according to claim 2, wherein:
the lower surface includes a second flat-shaped portion oriented in the down direction while being along the facing portion; and
the lower end of the protective member is located above the second flat-shaped portion.

6. The electronic component according to claim 2, wherein:
the lower surface includes a second flat-shaped portion oriented in the down direction while being along the facing portion; and
a position of the lower end of the protective member in an up-down axis is substantially same as a position of the second flat-shaped portion in the up-down axis.

7. The electronic component according to claim 1, wherein, when viewed in the down direction, a depressed portion that overlaps with the protective member is provided on the lower surface.

8. The electronic component according to claim 1, wherein:
the external electrode further includes a plating layer; and
the plating layer is located below the base layer and is in contact with the base layer.

9. The electronic component according to claim 8, wherein an external edge of the plating layer is located below the protective member.

10. The electronic component according to claim 1, wherein the component main body has a rectangular parallelepiped shape.

11. The electronic component according to claim 1, wherein edges of the component main body are rounded.

12. The electronic component according to claim 1, wherein the component main body and the protective member include a ceramic material.

13. The electronic component according to claim 12, wherein the ceramic material of the component main body is the same as the ceramic material of the protective member.

14. The electronic component according to claim 1, wherein the protective member has a ring shape.

15. An electronic component, comprising:
a component main body having a lower surface, wherein the lower surface defines a recessed channel surrounding an electrode mounting portion;
an external electrode including a base layer disposed on the electrode mounting portion; and
a protective member disposed in the recessed channel and contacting an external edge of the base layer,
wherein a lower-most surface of the protective member is substantially coplanar with or recessed relative to the electrode mounting portion.

16. The electronic component according to claim 15, wherein the protective member is in contact with a bottom wall and a side wall of the recessed channel.

17. The electronic component according to claim 15, further comprising a plating layer disposed on and in contact with the base layer, wherein an external edge of the plating layer is located below the protective member.

18. An electronic component, comprising:
a component main body having a lower surface and a plurality of side surfaces;
a plurality of external electrodes on the lower surface, at least one of the plurality of external electrodes being adjacent to a corner formed by two of the plurality of side surfaces; and
a plurality of protective members, each protective member corresponding to one of the plurality of external electrodes and disposed in a recessed portion of the lower surface to surround a periphery of the corresponding external electrode,
wherein each protective member does not project in a downward direction beyond a plane defined by its corresponding external electrode.

19. The electronic component according to claim 18, wherein the plurality of external electrodes comprises at least four external electrodes, with each of the at least four external electrodes being disposed adjacent to a respective corner of the lower surface.

20. The electronic component according to claim 18, wherein at least one of the plurality of external electrodes is an interior electrode surrounded by other external electrodes and is not adjacent to any of the plurality of side surfaces.
